(19) United States
(12) Patent Application Publication
(10) Pub. No.: US 2008/0299029 A1
(43) Pub. Date: Dec. 4, 2008

(54) Gas-Phase Process for Growing Carbon Nanotubes Utilizing Sequential Multiple Catalyst Injection

(76) Inventors: Martin P. Grosboll, Kingwood, TX (US); Richard E. Smalley, Houston, TX (US); Kenneth A. Smith, Houston, TX (US)

Correspondence Address: WILLIAMS, MORGAN & AMERSON, 10333 RICHMOND, SUITE 1100, HOUSTON, TX, 77042, US

(21) Appl. No.: 11/609,984

(22) Filed: Dec. 13, 2006

Related U.S. Application Data
(60) Provisional application No. 60/750,198, filed on Dec. 14, 2005.

(51) Int. Cl. D01F 9/12; B01J 8/08

(52) U.S. Cl. 423/447.1; 422/232; 977/742

(57) ABSTRACT

This invention relates generally to a method and apparatus for making carbon nanotubes from a flowing gaseous carbon-containing feedstock, such as CO, at superatmospheric pressure and at temperatures between about 500° C. and about 2000° C. utilizing a reactor wherein the flowing carbon-containing feedstock sequentially passes multiple points of catalyst injection, where the catalyst is provided by the decomposition of one or more catalyst precursor species, such as Fe(CO)₅. In one embodiment, a catalyst cluster nucleation agency is employed to facilitate metal catalyst cluster formation. The reactor permits broad control over the reaction conditions, and enables addition of controlled amounts of catalyst over the length of the conduit reactor. The invention provides higher catalyst productivity because more catalyst precursor is used to form small active catalyst clusters versus forming catalyst clusters that grow along the reactor into large clusters, which are inactive for carbon nanotube production.

This application claims priority from U.S. provisional patent application Ser. No. 60/750,198, filed on Dec. 14, 2005, which is incorporated herein by reference.

### FIELD OF THE INVENTION

This invention relates generally to a method for making carbon nanotubes. In particular, the invention relates to a method for growing carbon nanotubes in the gas phase at temperatures between about 500° C. and about 2000° C. utilizing a reactor in which a flowing carbon-containing feedstock is injected with a gas comprising a catalyst precursor at sequential multiple injection points along the longitudinal axis of the reactor, which is the primary direction of gas flow in the reactor.

### BACKGROUND OF THE INVENTION

Fullerenes are closed-cage molecules composed entirely of sp²-hybridized carbon atoms, arranged in hexagons and pentagons. Fullerenes (e.g., C₆₀) were first identified as closed spheroidal cages produced by the condensation of vaporized carbon. Fullerene nanotubes are fullerenes that are cylindrical structures of sp²-hybridized carbon atoms. The walls of these cylindrical structures are seamless graphene tubes. Fullerene nanotubes may exist in nested arrangements with one tube enclosed coaxially within one or more other tubes.

Carbon nanotubes are useful in numerous applications including, but not limited to, electromagnetic shielding, electrostatic dissipation, radiofrequency interference shielding, electron emitters, flat panel displays, electronic devices, conductive coatings, dielectric materials, fibers, and reinforcing materials.

Carbon nanotubes can be produced by various methods, including, but not limited to, vaporizing carbon in an arc between carbon electrodes containing a transition metal, laser-based co-evaporation and re-condensation of carbon and catalytic metals, exposure of carbon-bearing feedstock gas to catalytic particles that are supported on refractory materials, introduction of gas-suspended (or “floating) catalytic particles to a feedstock gas, or gas phase reactions involving transition metal catalysts and a carbon feedstock gas.

Essentially, all the known processes for making carbon nanotubes require at least one transition metal catalyst or a combination thereof. In all the known methods, the catalyst is a “once-through” catalyst, in that it remains with carbon nanotube product until removed by a process that follows the nanotube production. In certain processes, such as CVD (Chemical Vapor Deposition) methods in which the catalyst metal resides on a support material, the support for the catalyst metal may also be removed in one or more subsequent purification processes.

In a gas-phase method described by Nikolaev et al. (“Gas-phase Catalytic Growth of Single-Walled Carbon Nanotubes from Carbon Monoxide,” Chemical Physics Letters, 313, 91, 1999) and U.S. Pat. No. 6,761,870, “Gas Phase Nucleation and Growth of SWNT from High Pressure CO”, which is hereby incorporated by reference in its entirety, carbon nanotubes are made at high temperature and superatmospheric pressure (i.e., greater than one atmosphere) using carbon monoxide (CO) as the carbon-containing feedstock gas and a catalyst generated from a transition metal-containing catalyst precursor, for example, iron pentacarbonyl. In this method, the catalyst precursor is injected at one end of a reactor, generally near the injection point of the carbon-containing feedstock gas, and forms metal catalyst clusters in situ. The clusters of metal atoms, formed from the decomposition products of a catalyst precursor or precursors, serve as the active catalyst for carbon nanotube nucleation and growth.

Nikolaev et al. describe an apparatus and process to make single-wall carbon nanotubes with superatmospheric-pressure CO wherein the catalyst precursor injection is at the inlet of the reactor. See also Bronikowski et al., “Gas-Phase Production of Carbon Single-Walled Nanotubes from Carbon Monoxide via the HiPco Process: A Parametric Study,” J. Vac. Sci. Technol. A 19(4), 1800 July/August 2001. In both Nikolaev and Bronikowski, the catalyst, formed in situ, is no longer active after exiting the reactor and is not recirculated back through the reactor. In both Nikolaev and Bronikowski, the yield of single-wall carbon nanotubes is low due to a low conversion ratio of carbon feedstock to nanotubes per pass in the reactor.

Thus, there remains a need for a method that increases the conversion ratio of carbon to carbon nanotubes per pass in a gas phase reactor and a cost-effective process to make high volumes of carbon nanotubes.

### SUMMARY OF THE INVENTION

One embodiment of the invention is a method for producing carbon nanotubes that comprises the steps of: (a) providing a carbon-containing feedstock gas stream comprising a carbon-containing feedstock gas in a conduit reactor wherein the temperature of the carbon-containing feedstock gas is in a range between about 500° C. and about 2000° C.; and (b) injecting more than one catalyst precursor gas stream comprising a transition-metal catalyst precursor along the longitudinal axis of the conduit reactor through more than one catalyst precursor injection point connected to the conduit reactor at different sequential locations along the longitudinal axis of the conduit reactor, wherein each gaseous catalyst precursor mixes with the carbon-containing feedstock gas and decomposes to form active catalyst clusters in the carbon-containing feedstock gas, and wherein the active catalyst clusters catalyze the formation of carbon nanotubes from the carbon-containing feedstock gas in a carbon feedstock mixed stream.

In some embodiments, the carbon feedstock mixed stream is the gas stream in the reactor in a first mixing zone and subsequent to the first mixing zone, and may comprise catalyst precursor gas components, catalyst, carbon nanotubes, and other reaction products. The injecting of the catalyst precursor gas stream can be controlled by temperature, pressure, flow or a combination thereof to promote the formation of metal catalyst clusters active for carbon nanotube initiation and growth. The catalyst precursor streams can comprise different catalyst precursors. Heat can be removed from the carbon feedstock mixed stream exiting the reactor and returned to the carbon-containing feedstock gas provided to the conduit reactor. The carbon nanotube material can be separated from the carbon feedstock mixed stream by a gas/solids separation means, such as by passing the carbon feedstock mixed stream through a screen or filter. The composition of the gas can be modified after separating the carbon nanotube material from the carbon feedstock mixed stream, such as by removal of various gaseous reaction products. The carbon-containing feedstock gas can be recirculated back to the inlet of the reactor, such as by mechanical means of gas compression. In one embodiment, the carbon-containing feedstock gas comprises carbon monoxide. In another embodiment, the carbon-containing feedstock gas is at a pressure between about 3 and about 300 atmospheres. In another embodiment, the carbon-containing feedstock gas is at a pressure between about 10 and about 100 atmospheres.

In another embodiment, at least one of the catalyst precursor gas streams comprises at least one transition metal selected from the group consisting of Group VIB metals, Group VIIIB metals, and mixtures thereof. In yet another embodiment, the transition-metal catalyst precursor comprises a metal-containing compound of a metal selected from the group consisting of tungsten, molybdenum, chromium, iron, nickel, cobalt, rhodium, ruthenium, palladium, osmium, iridium, platinum and mixtures thereof. In yet another embodiment, the metal-containing compound is a metal carbonyl. In yet another embodiment, the metal carbonyl is selected from the group consisting of Fe(CO)₅, Co(CO)₆, and mixtures thereof In yet another embodiment, the metal-containing compound is a metallocene. In yet another embodiment, the metallocene is selected from the group consisting of ferrocene, cobaltocene, ruthenocene and mixtures thereof. In yet another embodiment, at least one of the catalyst precursor gas streams comprises CO. In yet another embodiment, the transition-metal catalyst precursor is added to the carbon-containing feedstock gas steam, resulting in a catalyst precursor concentration of about 0.01 ppm to about 100 ppm of catalyst precursor in the carbon-containing feedstock. In yet another embodiment, the transition-metal catalyst precursor is added to the carbon-containing feedstock gas stream in an amount to yield about 0.1 ppm to about 10 ppm catalyst precursor concentration in the carbon-containing feedstock.

In yet another embodiment, at least one of the catalyst precursor streams is provided at a temperature in the range of from about 70° C. to about 300° C. In yet another embodiment, the carbon-containing feedstock stream is provided at a temperature in the range of from about 900° C. to about 1100° C. In yet another embodiment, the catalyst precursor gas stream, the carbon-containing feedstock stream or both, further comprises a catalyst promoter. In yet another embodiment, a catalyst promoter is selected from the group consisting of thiophene, H₂S, volatile lead, bismuth compounds and combinations thereof. In yet another embodiment, the catalyst precursor gas stream further comprises a nucleating agent. In yet another embodiment, the nucleating agent is laser light photons. In yet another embodiment, the nucleating agent comprises a nucleating metal that is different than the transition metal in the catalyst precursor. In yet another embodiment, the nucleating metal comprises a decomposition product of a metal-containing compound selected from the group consisting of Ni(CO)₄, W(CO)₆, Mo(CO)₆, and mixtures thereof.

In another embodiment, an apparatus for producing carbon nanotubes comprises (a) a gas stream conduit reactor which has a longitudinal axis and which is capable of providing a carbon-containing feedstock gas at a temperature between about 500° C. and about 2000° C.; (b) more than one gaseous catalyst precursor conduit connected to the gas stream conduit reactor at sequential different locations along the longitudinal axis of the reactor to provide more than one catalyst precursor gas stream to the gas stream conduit reactor at different sequential locations along the longitudinal axis of the reactor; and (c) more than one mixing zone along the longitudinal axis of the gas stream conduit reactor wherein each mixing zone is associated with an inlet of one of the catalyst precursor conduits and in which zone the carbon-containing feedstock gas stream mixes with the catalyst precursor gas streams provided along the longitudinal axis of the reactor, wherein each of the more than one mixing zone is maintained under reaction conditions to form carbon nanotubes, and wherein the carbon-containing feedstock gas and carbon nanotubes are contained in a carbon feedstock mixed stream.

In yet another embodiment, each of the gaseous catalyst precursor conduits is associated with a gaseous catalyst precursor conduit control element to maintain catalyst precursor gas parameters of temperature, pressure, and flow conducive to the initiation of formation of active catalyst for the production of carbon nanotubes. In yet another embodiment, the gaseous catalyst precursor conduit control element controls the temperature of the gaseous catalyst precursor. In yet another embodiment, the apparatus further comprises more than one conduit reactor control element associated with the mixing zones along the along the longitudinal axis of the gas stream conduit reactor. In yet another embodiment, the more than one conduit reactor control element controls the temperature of the more than one mixing zone. In yet another embodiment, the apparatus further comprises a means for heat recovery from the flow exiting the reactor, wherein the recovered heat is returned to the feedstock flow entering the reactor. In yet another embodiment, the apparatus further comprises a means for gas/solids separation. In yet another embodiment, the apparatus further comprises a means for gas composition modification subsequent to nanotube formation, such as to remove gaseous reaction byproducts. In yet another embodiment, the apparatus further comprises a means for gas recirculation, such as one that operates mechanically by gas compression.

### BRIEF DESCRIPTION OF THE DRAWINGS

FIG. 1 is a schematic representation of a reactor with multiple sequential catalyst injection ports along the longitudinal axis of the reactor.

FIG. 2 is a cross-sectional diagram of a central section of a cyclone reactor.

### DETAILED DESCRIPTION OF SPECIFIC EMBODIMENTS

Catalyst precursor decomposition, formation of active catalyst clusters from the metal liberated from the catalyst precursor, and carbon nanotube growth and initiation are processes that are highly dependent upon the concentration and type of catalyst precursor, the decomposition conditions (ambient temperature and pressure) of the catalyst precursor, the type and concentration of any catalyst cluster nucleation agency (if any), the type of carbon-containing feedstock, the ambient temperature and pressure conditions in the reactor for nanotube initiation and growth, and the residence time of the active catalyst cluster in the nanotube reactor. As an example, the formation of active metal iron atom catalyst clusters from the decomposition of iron pentacarbonyl and catalysis of carbon nanotubes from carbon monoxide as the carbon-containing gas using these iron-based catalyst clusters will be described below.

In CO at a pressure of 30 atmospheres, the catalyst precursor, iron pentacarbonyl, present at low concentrations in a predominantly CO environment, begins to decompose substantially at a temperature of about 300° C. At higher CO pressures, higher temperatures are required for the catalyst precursor decomposition rates to become substantial. Once decomposition of the catalyst precursor begins, the decomposition products engage in a series of gas-phase reactions that ultimately can form small metal clusters. The species that react to initiate cluster formation are often intermediate decomposition products of the precursor. For example, intermediate decomposition products of iron pentacarbonyl catalyst precursor include Fe(CO)ₙ, where n can be 0, 1, 2, 3 or 4. At temperatures above about 600° C. and at pressures of 30 atmospheres, the iron carbonyl dissociates predominantly to atomic iron, but this process proceeds through intermediate species.

Metal cluster initiation, which begins the cluster growth process, is often relatively slow, and can be the rate-limiting process in cluster formation and growth. In order to form active metal atom clusters, such as Fe atom clusters, from the precursor molecules and/or partially dissociated precursor molecules, Fe(CO)ₙ, the cluster must grow to a minimum size, typically 4 to 5 metal atoms, to catalyze nanotube initiation. As Fe(CO)₅ dissociates into Fe atoms and CO, the rate and extent of metal aggregation are confounded by (1) competing back reactions of CO (primarily from the CO feedstock gas) wherein the Fe metal atoms react with CO to recombine with Fe and re-form CO ligand-to-Fe atom bonds, (2) the low probability of Fe atoms colliding at a fortuitous energy collision trajectory to form a Fe—Fe dimer, and (3) the Fe electronic configuration, which results in the low binding energy (i.e., on the order of 1 eV) for Fe—Fe dimers. This low binding energy makes the likelihood of two free iron atoms clustering together as a result of a two-body collision to form the Fe—Fe dimer at the high temperatures conducive to form nanotubes generally unfavorable. However, when a two-body collision does result in forming a Fe—Fe dimer, adding more Fe atoms to the Fe dimer proceeds more easily. As the Fe cluster grows, the adding of Fe atoms to the cluster becomes more and more favorable because 1) the collisions involve larger cross-sectional areas, and 2) the binding energy of the added Fe atom to the Fe cluster is greater. Although, once an intact Fe—Fe dimer is formed and metal cluster formation proceeds more readily, higher ambient temperatures can confound the formation of clusters and cause them to shrink by promoting the evaporation of the iron atoms from the clusters.

Once a transition metal cluster of a minimum nanometer-scale size is formed in the presence of CO, it then can serve as an effective catalyst for the Boudouard reaction:

2CO→C+CO₂.

At elevated temperatures, this reaction occurs rapidly on the surface of transition metals, and can promote the formation of carbon sheets (graphene), in which carbon atoms are bonded in polycyclic aromatic structures, typically in sheets of adjoining six-atom rings. If the catalyst particle cross-sectional dimension is in a range of between about 0.3 and about 10 nanometers, then such a catalyst cluster is capable of promoting the formation of fullerene nanotubes.

A small metal cluster in contact with a polycyclic aromatic structure at elevated temperature is conducive for carbon nanotube formation instead of the formation of closed fullerenes. Hafner et al. (“Catalytic Growth of Single Wall Carbon Nanotubes from Metal Particles,” Chemical Physics Letters 296, 195, 1998) indicate that small metal clusters enable the formation of fullerene nanotubes with an active catalyst particle at one end (the lowest energy configuration for the carbon as it assembles into a structure in contact with the nanometer-scale catalyst). Such catalytic production of carbon nanotubes is effective only when the catalyst itself is small, i.e., less than about 3 nanometers in diameter. If the catalyst particle diameter grows larger than about 3 nanometers, Hafner et al. state that the lowest-energy configuration of the polycyclic aromatic sheet is one that covers the surface of the catalyst particle, and, thus making the catalyst inactive for nanotube growth.

The product of the superatmospheric-pressure CO nanotube growth process can comprise carbon nanotubes, such as single-wall carbon nanotubes, with a diameter range between 0.6 and 2 nanometers (nm) with the bulk of the diameter distribution falling between 0.6 and 1.0 nm. The individual tubes typically bundle together in the form of “ropes” in which large numbers of parallel tube segments aggregate and are held together by van der Waals forces. The catalyst metal in the product material is observed to be almost entirely in the form of 2 to 10-nm diameter particles. Additionally, the carbon product contains varying amounts of graphitic carbon, amorphous carbon and non-nanotube carbon that can be described as imperfectly-formed closed and unclosed fullerene-like structures which surround catalyst particles and adhere to the ropes of nanotubes. Most catalyst particles are overcoated with a well-defined carbon layer, or graphitic layers, but they participate as catalysts in the generation of the imperfectly-formed unclosed fullerenes prior to the time at which they become overcoated with the relatively-impermeable carbon layer that stops feedstock gas from reaching the catalyst surface, and consequently, catalytic activity.

Thus, the nanotube growth mechanism, in simplistic terms, can be described as one in which (1) the catalyst precursor begins to decompose upon its contact with hot CO, (2) a small metal cluster containing transition metal atoms forms, (3) the cluster catalyzes the Boudouard reaction producing carbon, (4) the carbon forms a polycyclic aromatic structure in the form of a fullerene tube, which remains attached to the catalyst particle, and (5) the Boudouard reaction continues to create carbon which is conducted to, and then becomes bonded to, the “live end” of the tube structure causing the length of the tube to increase.

Under nanotube growth conditions, the growth environment comprises hot superatmospheric-pressure CO, transition-metal clusters that catalyze the growth of nanotubes, a small amount of catalyst precursor in various states of decomposition, and small clusters containing transition metal catalyst atoms. Catalyst precursor decomposition products and clusters containing transition metals can collide and aggregate with active catalyst particles, resulting in larger catalyst particles. Likewise, catalyst precursors and various decomposition products containing transition metal atoms can collide with the sidewalls of a growing nanotube, and can leave metal atoms on the sidewall, which are weakly attracted to the sidewall, but mobile enough to migrate along it. If these metal atoms migrate to the active catalyst particle, they are able to aggregate with it and increase the catalyst particle size. Through these aggregation processes, the catalyst particle ultimately reaches a size at which the formation of polycyclic aromatic sheets aligned on its surface begins to compete thermodynamically with the continued growth of the nanotube. If the catalytic particle becomes covered by graphitic polycyclic aromatic sheets, it is no longer able to catalyze the formation of carbon nanotubes because the feedstock gas can no longer reach its surface. In the high-pressure carbon monoxide process, the catalyst particles are active for only fractions of a second, and the bulk of the nanotube growth occurs in the immediate vicinity of the region where the heated CO and the catalyst precursor are mixed, i.e. at the inlet end of the reactor.

To prolong the life of the active catalyst, it is necessary to maintain small catalyst particle sizes. And, to maintain small catalyst particle sizes requires minimizing the “fattening” of the catalyst particles which happens by aggregation of the metal atoms from the gas surrounding the growing nanotube onto the catalyst particle. This aggregation starts when the catalyst particles form and flow from the inlet of the reactor, through the length of the reactor to the exit of the reactor. The aggregation continues during the residence time of the particle in the heated portion of the reactor. After the catalyst particles aggregate to a certain size, the catalyst particles overcoat and are no longer able to catalyze the initiation and growth of carbon nanotubes.

Certain embodiments of the present invention provide a method and apparatus for making high purity carbon nanotubes at a high production rate. These embodiments can apply to processes wherein active catalyst clusters are formed by rapid nucleation and wherein the active catalyst clusters are maintained in a low concentration environment of the catalyst precursor. Certain embodiments of the invention provide a process for making carbon nanotubes with a high conversion ratio of the carbon in the carbon-containing feedstock gas to carbon nanotubes, high catalyst productivity, long catalyst lifetime, and minimal formation of imperfect graphene materials in the carbon nanotube product.

In one embodiment, the present invention relates to a process for a gas-phase production of carbon nanotubes utilizing a carbon-containing gaseous feedstock and a catalyst precursor, wherein the catalyst formed in the reactor from the catalyst precursor has high productivity and wherein the reactor has multiple catalyst injection points configured along the longitudinal axis of the reactor.

In another embodiment, a process for producing carbon nanotubes utilizes high pressure, high temperature CO and a catalyst precursor, wherein the catalyst is formed in a reactor wherein the catalyst precursor is injected into the reactor at multiple sequential injection points along the longitudinal axis of the reactor, such as a cyclone reactor or a linear reactor, and the catalyst has high productivity and the carbon nanotube product formed has a low residual catalyst content.

In another embodiment, a process for making carbon nanotubes in the gas phase comprises reacting high-temperature carbon monoxide at superatmospheric pressure with a transition metal catalyst in a cyclone reactor wherein the catalyst is formed from the decomposition of catalyst precursor molecules that were injected at multiple sequential catalyst injection points along the longitudinal axis of the reactor.

In another embodiment, a catalyst cluster nucleation agency is employed to enable more rapid, stable clustering of the metal atoms generated from the decomposition of metal catalyst precursors to form many small, active catalyst particles instead of large, inactive ones. Catalyst cluster nucleation can be promoted by the presence of already-formed nanotubes in the reacting gas flow. The sequential injection of each catalyst precursor and associated controls of each catalyst precursor gas allow broad control over the reaction conditions, and enables the addition of substantial amounts of catalyst in a distributed volume that improves the conversion ratio of carbon in the CO feedstock gas to carbon nanotubes. The sequential injection of catalyst precursor gas streams also enables production of nanotubes with lower concentrations of metal catalyst in the carbon feedstock mixed gas stream and also minimizes the production of graphitic sheet carbon not in the form of carbon nanotubes. In one embodiment, the invention also involves recovery of a nanotube product from the process through the action of a cyclone, which is a part of the reaction vessel. In one embodiment, the process economics are improved by recovering substantial amounts of heat from the gas exiting the reactor and using it to heat the incoming carbon-containing gas flow.

In another embodiment, small clusters of transition metal catalyze the formation of carbon nanotubes from a carbon-bearing feedstock gas in environments where the temperature is between about 600° C. and about 1300° C. Clusters of transition metal catalysts are also known as nanotube growth catalysts. Transition metal elements are those found in Groups IB through VIIIB of the periodic table, however, some transition metals and some mixtures of transition metals are more effective as carbon-nanotube-formation catalysts than others. Generally, metals from Group VIB, Group VIIIB and compositions thereof are preferred. The carbon-containing feedstock gas is a gas or gas mixture comprising at least one carbon-containing compound in the gas phase, such as carbon monoxide or hydrocarbon gases.

In another embodiment, a process for making carbon nanotubes comprises high pressure CO as the carbon-containing feedstock and iron pentacarbonyl as the catalyst precursor. In another embodiment, a process for making carbon nanotubes comprises the use of a carbon-containing feedstock gas comprising hydrocarbons.

In another embodiment, the present invention relates to an apparatus for producing carbon nanotubes, wherein reactor has multiple sequential catalyst injection points along the longitudinal axis of the reactor. Although some of the injection points may be sequential, in addition to these sequential addition points, there may be some injection points that are in the same cross-section perpendicular to the longitudinal axis of the reactor.

In another embodiment, a method for producing carbon nanotubes generally comprises the steps of: (a) providing a feedstock gas stream at a temperature appropriate for nanotube growth; (b) providing a means of introducing nanotube growth catalyst to the feedstock stream at two or more sequential points; and (c) recovering nanotube product.

In another embodiment, the method can also comprise (d) providing a heated, high-pressure (3-300 atmospheres) CO gas stream at a temperature that is (i) above the decomposition temperature of the catalyst precursor and (ii) above the minimum Boudouard reaction initiation temperature, to form a heated CO gas stream; (e) partitioning a gaseous catalyst precursor stream into multiple individual gas streams; (f) providing at least one independent catalyst precursor stream that differs from the first in composition, temperature, pressure or a combination thereof; (g) separately and sequentially mixing the heated CO gas stream with each of the multiple individual gaseous catalyst precursor streams in distinct mixing zones to rapidly heat the catalyst precursor to a temperature that is (i) above the decomposition temperature of the catalyst precursor, (ii) sufficient to promote the rapid formation of catalyst metal atom clusters and (iii) sufficient to promote the initiation and growth of nanotubes by the Boudouard reaction, to form a suspension of carbon nanotube products in the resulting gaseous stream emerging from each of the mixing zones. In addition to the steps above, the process can also comprise steps selected from: (h) mixing the carbon-containing feedstock and catalyst precursor in zones that are part of a “cyclone” component in a reactor (such as in a “cyclone reactor”) that acts to concentrate the carbon nanotube product in a particular portion of the gas flow; (i) adding heat to the gas flow downstream of one or more of the mixing zones; (j) passing the carbon-containing feed flow containing carbon nanotube product to a first means for collection of the carbon nanotube product; (k) recovering additional product that is not recovered by the first collection means by using a second collection means; (l) recovering heat from the effluent gas emerging from the heated part of the reactor, and (m) recycling recovered heat to heat a portion of the CO introduced to the CO gas stream in step (a), above. Steps (a)-(m), inclusive, and subsets of these steps, may be construed to comprise inventive aspects of the present invention.

The present invention also provides an apparatus for producing single-wall carbon nanotube products comprising: (a) a reaction vessel comprising multiple sequential reactant introduction points leading to multiple reactant mixing zones, multiple reaction zones and one or more product recovery zone; (b) a first reactant supply means providing a feedstock gas to said reactant introduction zones; (c) a second reactant supply means for providing a catalyst precursor gas to a second reactant introduction zone; (d) a set of multiple mixing and reacting zones for rapidly and intimately mixing the gas flows from the first and second reactant supply means, promoting nanotube formation and growth, said reacting zones being arranged so that nanotube product from upstream zones flows into and through other (i.e. downstream) mixing and reacting zones; (e) heating means for maintaining said mixing, reaction and product separation zones at an elevated temperature; and (f) gas/solids separation means to remove solid carbon nanotube products from the gas flows exiting said reaction zone; and (g) heat recovery means that removes heat from the flow emerging from the said reactant mixing and reacting zones, and returning that heat to the first reactant supply conduit, i.e. the carbon-containing feedstock gas stream.

Further details regarding embodiments of the invention are given below.

### Raw Materials

1. Carbon Source

In the present invention, the carbon source for growing carbon nanotubes can be any carbon-containing gas or compound that can be vaporized or sublimed. In one embodiment of the present invention, the carbon source for growing carbon nanotubes is carbon monoxide (CO). CO gas is readily available and can be used with minimal pretreatment. The CO may be filtered to remove unwanted particulate contaminants. In addition, adsorption beds and/or cryogenic separation can be employed to remove any unwanted gaseous contaminants in the CO feedstock. In one embodiment of the present invention, a major portion of the CO feed gas stream may be recycled from the gaseous effluent from the process. The carbon feedstock gas may also be any gaseous hydrocarbon. Examples of typical hydrocarbons include, but are not limited to, alkanes having one to six carbon atoms, such as methane, alkenes having one to six carbon atoms, such as ethylene, alcohols having one to six carbon atoms, such as methanol, and aromatics having one to twelve carbon atoms, such as benzene.

2. Catalyst Precursor

Carbon nanotube formation from a carbon-containing gas is catalyzed by small clusters of transition metal atoms. These small metal catalyst clusters may be entrained in a gas flow or reside at the “growing” end of a carbon tube after nanotube growth has been initiated. A catalyst precursor gas can include, but is not limited to, a gas stream comprising (1) a precursor chemical, (2) chemicals whose reaction products form an active catalyst, (3) a catalyst precursor on, or chemically combined with, a support, (4) chemicals that react to form a catalyst support along with those that form an active catalyst on said support, or (5) a combination thereof. The active catalyst can also include pre-formed catalyst particles and/or a catalyst on a support. Typically, the catalyst precursor, from which the active catalyst cluster forms, is a transition metal-containing compound that, if not gaseous as obtained, can be derived from a volatile liquid or sublimable solid.

The size of a catalyst metal atom cluster can affect the carbon product produced, such as the types, sizes and selectivity of carbon nanotubes, as well as types and forms of non-nanotube product, such as amorphous and/or graphitic carbon coatings on the catalyst cluster. Useful catalytic metals include all transition elements, preferably the Group VIB and/or Group VIIIB transition metals and combinations thereof. Such metals include tungsten, molybdenum, chromium, iron, nickel, cobalt, rhodium, ruthenium, palladium, osmium, iridium, platinum, and mixtures thereof. Generally preferred are catalyst systems based on Fe (iron) or Co (cobalt). The preferred catalyst precursor compounds are metal carbonyls (such as Fe(CO)₅ and Co(CO)₆). Metallocene precursors such as ferrocene (FeCp₂), cobaltocene (CoCp₂), or ruthenocene (RuCp₂) can also be used as catalyst precursors.

3. Nucleating Agents and Catalyst Promoters

In certain embodiments, the process of the present invention is based, in part, on the provision of rapid, near simultaneous formation of the active catalyst metal atom clusters of the appropriate size, and initiation of carbon nanotube growth. In order to form metal atom clusters (e.g. Fe atom clusters) from the precursor molecule and its dissociation fragments (such as, e.g., Fe(CO)₅ and Fe(CO)ₙ, where n can be 0, 1, 2, 3 or 4), the cluster must grow to a minimum size, typically 4-5 metal atoms, in order to catalyze nanotube initiation. In the decomposition of Fe(CO)₅ into Fe atoms and CO, the rate and extent of metal aggregation are confounded by (1) the competing back reaction in which CO and Fe metal atoms recombine to form CO ligand-to-Fe atom bonds, (2) the low probability of Fe atoms colliding at a favorable energy and collision trajectory to form a Fe—Fe dimer, and, (3) the Fe electronic configuration, which controls the low binding energy of Fe—Fe dimers (i.e., on the order of 1 eV). This low binding energy reduces the likelihood of forming a Fe—Fe dimer from two free iron atoms bonding together as a result of a two-body collision at the high temperatures conducive to form nanotubes. However, when a collision does result in forming an intact Fe—Fe dimer, adding more Fe atoms to the Fe—Fe dimer proceeds more readily. As the Fe cluster grows, adding more Fe atoms to the cluster becomes more and more favorable because 1) the collisions involve clusters with larger cross-sectional areas, and 2) the higher binding energy of the Fe atoms adding to the Fe cluster. Thus, once an intact Fe—Fe dimer is formed, metal cluster formation proceeds more readily. This clustering is offset and confounded by the evaporation of the metal atoms from the metal atom clusters at higher temperatures, such as those temperatures of nanotube formation and growth, and by recombination of the metal atoms with CO, if present.

However, when the mixing-zone temperature is at a temperature in which the predominant iron species is free iron atoms, more rapid nucleation can be achieved by including a nucleating agent, which also may be introduced in the catalyst precursor gas stream. Such a nucleating agent can be a precursor moiety that under the reaction conditions stimulates clustering by decomposing more rapidly and binding to itself or the predominant metal species (e.g. iron) more tightly after precursor dissociation. A nucleating agent that facilitates this rapid nucleation can be employed, and examples of such agents include, but are not limited to, metal carbonyls and other transition metal compounds with decomposition temperatures in the same range as the catalyst precursor compound (e.g. Fe(CO)₅). One example of a nucleating agent is nickel, which can be generated from the decomposition of Ni(CO)₄. Nickel can form stable dimers more readily to start the clustering of catalyst metal atoms.

Another effective means of enhancing the formation rate of carbon nanotubes in catalytic process is through the use of catalyst promoters. Generally, these compounds, when present in low concentrations, modify the surface activity of the active catalyst to enable the carbon nanotube formation reaction to proceed at a rate more favorable for the formation of high-quality carbon nanotubes. Such promoters include, but are not limited to, sulfur, volatile lead, thiophene, H₂S, bismuth compounds and combinations thereof Catalyst promoters can be added to the carbon-containing feedstock gas stream and/or any of the catalyst precursor gas streams.

### Process Description

In one embodiment, the process comprises supplying (1) a large flow of high-pressure, (e.g. between about 3 and about 300 atmospheres) of a carbon-containing gaseous feedstock, such as CO, that has been preheated to a temperature in the range of about 500° C. and about 2000° C., and, (2) more than one substantially lower-flow, separate catalyst precursor gas stream comprising a catalyst precursor gas (e.g., Fe(CO)₅) wherein the inlets for the catalyst precursor streams are sequentially arranged along the longitudinal axis (i.e. the main gas flow direction) of the reactor. The catalyst precursor gas streams may comprise at least one other carrier gas that can be the same or different than the carbon-containing feedstock gas, (e.g. CO) stream. The flow, temperature, and pressure of each catalyst precursor gas stream may be controlled individually and independently. Such control serves to introduce the catalyst precursor under preferred condition to the reaction process. The catalyst precursor gas streams are provided to a series of mixing zones, wherein the preheated carbon-containing gaseous feedstock (e.g. CO) flows sequentially through each mixing zone. Thus, in each mixing zone, the catalyst precursor interacts with the large flow of hot carbon-containing gas (e.g. CO). As the mixing proceeds, the catalyst precursor gas components act to provide new active catalyst clusters for the production of carbon nanotubes. The reactor can be of arbitrary length, and substantially more catalyst precursor gas can be added to the process than with a single catalyst injection-point at the inlet of a reactor. The sequential injection of the catalyst precursor permits greater amounts of catalyst to be active in the carbon-containing gas stream in the reactor at the same time versus a reactor configuration wherein the catalyst precursor injection is at one end, i.e. the inlet, of the reactor. The multiple injection of catalyst can increase the carbon-conversion ratio per pass from a ratio of about 1:10,000 (carbon atoms incorporated in the nanotube product to unreacted carbon atoms of the carbon feedstock gas entering the reactor) such as obtained in a reactor with one catalyst injection point at the inlet of the reactor, to typically more than 1:3,000, and typically more than 1:1,000, and even more typically to greater than 1:300 for simultaneous catalyst injections at multiple locations along the longitudinal axis of the reactor.

Some or all of the catalyst precursor gas flows, the carbon-containing feedstock gas, or both can contain a catalyst cluster nucleation agency employed to provide for rapid clustering of the catalyst precursor to form many small, active catalyst particles instead of fewer large, inactive ones. Such nucleation agencies can include 1) auxiliary metal precursors that promote clustering of the primary catalyst metal atoms, or 2) a provision for additional energy inputs (e.g., from a pulsed or CW laser) directed precisely at the region where cluster formation is desired.

In each individual reaction zone after the first, the surface of the nanotubes and/or nanotube ropes produced in the previous or upstream reaction zones provides a surface upon which catalyst clusters can form. Under these conditions, nanotubes nucleate and grow on these surface-resident catalyst clusters. Because of the substantially higher reaction rates for cluster formation on surfaces, this surface-mediated process will result in active catalyst cluster formation at much lower catalyst precursor concentrations than required for active catalyst cluster formation in the gas phase. This lower concentration, in turn, reduces the rate of cluster “fattening” which means that the catalyst clusters are active for longer periods of time before they become deactivated by carbon overcoating. This longer active catalyst lifetime further increases the ratio of carbon-to-carbon nanotube conversion per pass for the process. The rate of the main feedstock flow through the reactor, and the reactor geometry itself, determine the relative density of nanotubes interacting with the catalyst gas flow from the multiple injection ports. In one embodiment, the invention comprises a process wherein the nanotube concentration is controlled in conjunction with the catalyst precursor concentrations to achieve optimal nanotube production conditions. The control of the nanotube concentration comprises controlling the flowrates and compositions of the gases entering each individual reaction zone. The catalyst precursor composition present in one mixing zone and the adjacent reaction zone can be different than that present in one or more zones that are downstream of, or concentric with, the zone. Different transition metals, or mixtures thereof, for the catalyst precursor gas flows, and different forms of catalyst precursors, may be used in different mixing zones. This flexibility is desirable because the nanotube concentration and temperature in the gas flows in different reaction zones are usually different, and optimal formation of active catalyst depends on the conditions in the particular zone into which the catalyst precursor is introduced.

Certain embodiments of the apparatus and method of this application further enable production of nanotube product with substantially reduced amounts of imperfect graphene material. At each catalyst precursor gas injection point, only a small amount of catalyst precursor gas is introduced. The catalyst precursor gas introduced is at a temperature substantially lower than the main flow, but because its volume is substantially smaller than the main carbon-containing feedstock gas flow, the temperature of the main carbon-containing feedstock gas flow is not substantially reduced by the small catalyst precursor injections. In general, the temperature in the main carbon-containing feedstock gas flow will decrease as it passes through the series of mixing and reaction zones, but heat can be added to the flow along the length of the reactor. For instance, the length of the reactor can be heated to supply heat to the carbon-containing feedstock gas flow to make up for temperature losses due to the injection of the cooler catalyst precursor gas streams. In embodiments with highly exothermic reactions, heat can be transferred from the reaction zones in the reactor to control the reaction zone temperature. (The carbon nanotube product suspended in the flow improves heat transfer to the gas flow because of the high surface area, high radiation absorption and high thermal conductivity of the carbon nanotubes. At the temperatures pertinent to carbon nanotube formation, radiative heat transfer from the reactor wall to the nanotube product is quite efficient. The nanotubes can alternatively be heated by microwave or optical radiation and then transfer heat to the flowing feedstock gas.) Thus, a controlled temperature can be maintained in each of the individual mixing zones and reaction zones, and the reaction temperature can be maintained throughout the reactor. In contrast, a method having one sudden injection of a large catalyst precursor gas flow at the inlet end of a reactor provides substantially lower local reaction zone temperatures and is susceptible to substantial temperature gradients in the flow.

In certain embodiments of the present method, a uniform temperature is supplied to the reactor to provide improved control over reaction conditions to produce carbon nanotubes while minimizing the formation of other carbon forms, such as unwanted imperfect graphene material. At these controlled temperatures and lower gas-phase catalyst concentrations, the catalyst particles can stay active longer, but, ultimately, they will still become large enough to support the formation of well-ordered graphitic layers that will eventually overcoat and deactivate the catalyst particles. However, the uniform well-controlled temperatures of the reaction zones in the reactor provide that, when the catalyst particles become too large to support nanotube growth, they will overcoat quickly with well-closed graphite structures. This quick over-coating reduces the likelihood that the catalyst particles will catalyze the production of imperfectly-formed and unclosed fullerene-like structures surrounding catalyst particles and adhere to the ropes of nanotubes.

### Detailed Process Description

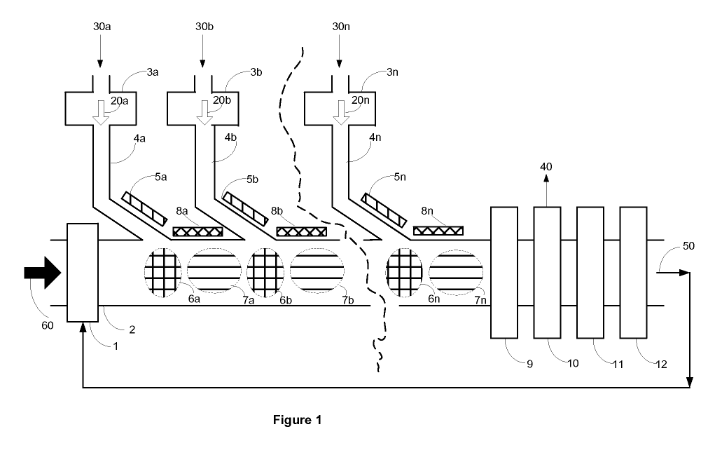

One embodiment of the process is shown in FIG. 1 and involves use of a heating means 1 that provides heat to a carbon-containing feedstock gas 60 flowing in a reactor conduit, 2. Each catalyst precursor source, 3a, 3b, . . . 3n, provides a catalyst precursor gas, 20a, 20b . . . 20n, each of which can be optionally introduced into each of the catalyst precursor gas conduits, 4a, 4b, . . . 4n, by a catalyst precursor carrier gas, 30a, 30b, . . . 30n. Each catalyst precursor gas conduit provides a means for introducing the catalyst precursor into the reactor conduit. Each catalyst precursor gas conduit is optionally associated with a control element, 5a, 5b, . . . 5n, that serves to control the flowrate, temperature, and/or pressure of the catalyst precursor gas flow immediately prior to introduction to the reactor conduit 2. The catalyst precursor can decompose and form the active metal catalyst clusters either in the precursor gas conduits, 4a, 4b . . . 4n, or just upon entering the reactor conduit, such as in each mixing zone 6a, 6b, . . . 6n. In the latter case, heated carbon-containing feedstock gas mixes with the catalyst precursor gas injected into each mixing zone. The carbon-containing feedstock gas 60 and a first catalyst precursor gas mix in the first mixing zone 6a. In this mixing zone, the catalyst precursor decomposes and/or reacts to form small clusters of active metal catalyst particles. The heated carbon-containing gas and active metal catalyst pass into a first reaction zone 7a, and then, sequentially, to a second reaction zone 7b, and through the desired number of reaction zones until reacting the last reaction zone 7n. Optionally, a control element 8a, 8b, . . . 8n, may be associated with one or more of each of the reaction zones, 7a, 7b, . . . 7n, to control the temperature, pressure and/or flow in the associated reaction zone. The flow exiting the first reaction zone 7a contains carbon nanotubes, and this flow enters a second mixing zone 6b where it mixes with a second catalyst gas flow emanating from a second catalyst gas conduit 4b which optionally is associated with a control element 5b to set the flowrate, temperature, and/or pressure of this flow. Passing from the second mixing zone, the gas mixture passes into a second reaction zone which is optionally associated with a control element 8b which can be used to control the temperature, pressure and/or flow in that reaction zone. The process apparatus can consist of multiple injection and reaction zones, analogous to those shown in FIG. 1, as the second reaction zone. Following the last reaction zone, the flow passes through a heat recovery means 9 that removes heat from the flow and optionally recovers it for such uses as heating the incoming carbon-containing gas. After passing through the heat recovery means 9 wherein the flow is cooled, the flow then passes into a separation means 10 for separation of gas and solids (e.g. a filter) wherein the solids 40 comprising carbon nanotubes and associated solid material (e.g. metal catalyst particles, solid impurities and non-nanotube solid carbonaceous material) are removed from the remaining gas flow. The gaseous flow exiting the separation means 10 then passes into a gas conditioning means 11 which modifies the composition of the flowing gaseous composition (e.g. removal of gaseous reaction products such as CO₂ from the flow). The flow then enters a recirculation means 12 (e.g. a compressor with associated vessels and piping), and the exiting flow 50 is returned to the heating means 1. Repositioning or omission of one or more of these means elements in the process configuration is within the scope of the invention.

In another embodiment of the invention, the process involves the production of carbon nanotubes from high-pressure carbon monoxide (CO) as the carbon-containing feedstock gas and iron pentacarbonyl (Fe(CO)₅) as a catalyst precursor gas. The heating means 1 is used to heat the carbon-containing feedstock gas to a temperature appropriate for the formation of carbon nanotubes, typically between about 500° C. and about 2000° C., more typically between about 700° C. and 1500° C. Heat supplied by the heating means 1 may be supplied, at least in part, from the heat recovery means 9, (e.g. a heat exchanger of an appropriate configuration for the process conditions), by electrical resistive or inductive heating, by combustion of a portion of the feedstock flow within the reactor, by combustion heating provided externally to the reactor, or by a combination of these methods. When the carbon-containing feedstock gas is CO, the feedstock gas from a compressor 12 passes through a heat exchanger that receives heat from the heat recovery means 9, and transfers some of that heat to the carbon-containing feedstock gas flow, and then passes into an electrical resistive heater assembly 1 in order to increase the carbon-containing gas flow temperature up to between about 900° C. and about 1100° C. The pressure of carbon-containing feedstock gas supplied to the resistive heater assembly 1 and the reactor conduit 2 is at a superatmospheric pressure between about 3 and about 300 atmospheres, preferably between about 10 and about 50 atmospheres.

The heated flow passes into a reactor conduit 2 having dimensions chosen to provide flow at an appropriate velocity and cross-sectional configuration for introduction into the mixing zone 6a. The choice of carbon-containing gas parameters (i.e., flowrate and pressure) is coordinated with the flowrates and pressures of the catalyst precursor gas introductions through the catalyst precursor gas conduits, 4a, 4b . . . 4n, so as to control the mixing process of the feedstock and catalyst precursor gases to provide substantial nucleation and initial growth of carbon nanotubes in each mixing zone, 6a, 6b, . . . 6n.

Catalyst precursor gas is provided from the catalyst precursor gas source 3a. The catalyst gas is prepared by methods known to those skilled in the art of gas mixing. A catalyst cluster nucleation agency may be added to the gas mix, and may be introduced with the catalyst precursor carrier gas (such as 30a). A catalyst promoter may also be added to the gas mix in the catalyst precursor carrier gas source.

In one embodiment wherein CO is the carbon-containing feedstock gas, a small fraction of the CO flow from the compressor 12 is diverted through a bubbler containing liquid iron pentacarbonyl (Fe(CO)₅). The bubbling, saturates the carrier gas with Fe(CO)₅ vapor, and downstream of the bubbler, the saturated flow is mixed with an appropriate amount of more CO, such as CO from the recycled CO flow, in order to provide the desired catalyst concentration to the reactor conduit 2. This catalyst precursor-gaseous flow that flows through each catalyst precursor conduit, 4a, 4b . . . 4n, is predominantly CO with between about 0.01 and about 1000 ppm (parts per million) Fe(CO)₅.

A control element (such as 5a) is associated with each catalyst precursor conduit (such as 4a). A control element such as this may be multi-functional and is critical to providing the proper flows in the mixing zone to provide substantial nucleation and initial growth of carbon nanotubes. A control element, such as 5a, provides temperature control and flow control with a cross-sectional area and flowrate for the catalyst precursor gas that is mixed with the carbon-containing feedstock gas flow 60 with a time and temperature evolution profile that yields effective nanotube nucleation and initial growth. This temperature and flow parameter control serves to prepare the catalyst precursor gas for effective interaction with the carbon-containing feedstock gas in the mixing zone. The injection of the catalyst precursor gas into a specific mixing zone can involve one or more injection ports, depending on the desired specific configuration of the reactor conduit 2.

In an embodiment wherein CO is the carbon-containing gas and the catalyst precursor gas comprises Fe(CO)₅, the initial phases of decomposition of Fe(CO)₅, and Fe cluster nucleation can take place prior to the injection of the catalyst precursor gas into the carbon-containing feedstock flow in the reactor conduit 2. These decomposition and cluster nucleation processes are enabled by controlling the temperature and flow in the control element (such as 5a). Typically, the catalyst precursor gas is delivered to a mixing zone in the reactor conduit 2 in the temperature range between about 70° C. and about 300° C.

The catalyst precursor gas flow, at a temperature and under flow conditions obtained through use of a control element, such as 5a, mixes with the carbon-containing feedstock gas in a mixing zone (such as 6a) to provide a catalyst concentration in the resulting reaction mixture of between about 0.01 and 100 ppm in the reactor conduit 2. In such mixing zone, metal catalyst clustering can either initiate or continue (depending on the state of the catalyst exiting the catalyst precursor conduit, such as 4a), and, with the active metal atom clusters present, carbon nanotube nucleation and growth begins. The combined processes of gas mixing, metal clustering and carbon nanotube nucleation and growth alter the temperature of the gas within the mixing zone, and care must be taken to see that the gas emerging from a mixing zone (such as 6a) and going into a reaction zone (such as 7a) is at a temperature appropriate for nanotube growth so that this growth will continue in the reaction zone.

In an embodiment in which CO is the carbon-containing feedstock gas and Fe(CO)₅ is the catalyst precursor, the gas emerging from a control element (such as 5a) is cooler than the carbon-containing gas in the main feedstock flow. Thus, the catalyst precursor flow can lower the temperature of the carbon-containing gas flow in the mixing zone. The nanotube formation process is exothermic, but at the reaction rates generally observed, the heat from the reaction process is insufficient to balance the cooling derived from mixing the main catalyst feedstock flow with the catalyst precursor gas, which is introduced at a lower temperature. The flow of cooler catalyst precursor gas must be kept relatively small, so that the gas in the mixing zone is kept at the high temperatures (generally greater than about 700° C.) required for nanotube nucleation and growth in CO. In the process of this embodiment, the concentration of catalyst in the mixture in the mixing zone is between about 0.01 and 100 ppm.

After the mixing of the carbon-containing gas and the catalyst precursor and/or catalyst, the flow proceeds into the reaction phase or zone (such as 7a), where the nanotube formation reaction continues, and the nanotubes formed are entrained in the flowing gas. The reaction zone is associated with a reactor conduit control element (such as 8a), which can be multi-functional. This control element can include cross-sectional dimensioning of the vessel through which the feedstock gas, catalyst and growing nanotubes flow, and it additionally can include heat addition or removal functions, as needed, to sustain the reaction proceeding within the reaction zone and to prepare the conditions of the flow at the end of this zone for its introduction to the next mixing zone (6b).

In an embodiment in which CO is the carbon-containing feedstock gas and Fe(CO)₅ is the catalyst precursor, a reactor conduit control element 8a, as well as subsequent analogous elements 8b up to 8n, where n is the final element of the reactor conduit, add both heat to the flow, and prepare the flow with a velocity that is conducive to its substantial mixing with the catalyst precursor gas flow in the next mixing zone. Each reactor conduit control element, such as 8a, is implemented by electrical heat input to the reactor wall via electrical heating and by appropriate sizing of the reactor passageway to provide the correct flow velocity for good mixing of the flow with the next catalyst gas injection. In this process, the catalyst is active only for a short time, and the length of the reaction zones are set, together with the gas flow, so that the gas residence time in the zone is only slightly longer than the lifetime of the active catalyst.

A second catalyst precursor gas, which may be the same or different than the first catalyst precursor gas, is prepared and delivered from the second catalyst precursor gas source (such as 3b), and passes through catalyst precursor conduit (such as 4b) with associated control element (such as 5b), all of which perform functions analogous to those of the corresponding elements 3a, 4a and 5a, respectively. However, the catalyst precursor gas flows and compositions associated with 3b, 4b and 5b may be the same or different than the gas flows and compositions associated with 3a, 4a and 5a. The flow emerging from reaction zone 7a, the flow of which contains both carbon-containing feedstock gas and nanotubes, mixes with the catalyst precursor gas emerging from the catalyst precursor conduit 4b in mixing zone 6b, where the addition of fresh catalyst precursor gas from the catalyst precursor conduit 4b provides for additional active catalyst cluster formation, nanotube nucleation and nanotube growth.

In an embodiment in which CO is the carbon-containing feedstock gas and Fe(CO)₅ is the catalyst precursor, the volume of catalyst precursor gas introduced in the second and subsequent injection points is generally different, and progressively less, than the amount injected in the preceding injector, as the surfaces of nanotubes present in the flow promote formation of active catalytic metal clusters and affect the catalyst precursor required.

The reactor comprises multiple catalyst precursor gas sources, conduits and control elements for the catalyst precursor gas flow, as well as multiple sequential mixing zone/reaction zone combinations as shown in FIG. 1. There is, however, a final reaction zone 7n from which the remaining feedstock and all the reaction products pass into a heat recovery means 9. Because all known carbon nanotube production processes operate at substantially elevated temperatures, heat management is critical to their economic operation. Heat recovery means 9 generally is a form of heat exchanger that transfers heat directly or indirectly (e.g. through a secondary heat transfer medium such as steam, liquid metal, or thermal fluids) to the feedstock gas prior to its introduction to the process.

In an embodiment in which CO is the carbon-containing feedstock gas and Fe(CO)₅ is the catalyst precursor, one heat transfer means is a tube-in-tube heat exchanger with process effluent flowing through the center tube and feedstock gas flowing in the outer tube.

After most of the heat is removed from the gas/solid nanotube product flow, the solid nanotube product is separated from the flow by a gas/solid separation means 10. This separation means can be a filter, a screen, a separator utilizing liquid droplets sprayed into the flow, a cyclone or other gas/solid separation means known in the art. The solids removed by the separation means are collected and stored. In one embodiment, the gas/solid separation means 10 is a metal screen filter, which effectively removes all solids from the gas flow.

The gaseous effluent from the gas/nanotube solids separator will generally contain gases other than the feedstock gas. The other non-feedstock gases are introduced as byproducts of the nanotube formation process and/or can be introduced by some methods of gas/solid separation. The gas emanating from the gas/solids separator 10 enters a gas conditioning means 11, which removes unwanted gaseous species from the flow. The gas conditioning means 11 may involve introducing the gas to reactants that selectively remove unwanted gases by chemical reactions. Other gas separation means, for example, selective absorption on high surface area materials, such as zeolites, or selective condensation of gases, or other means in the art of gas separation, may be used. Subsequent to the removal of unwanted gases, the gas conditioning means 11 may also add small amounts (0.01-100 ppm) of catalyst promoters or other species that are beneficial to the nanotube formation reaction process.

In an embodiment in which CO is the carbon-containing feedstock gas and Fe(CO)₅ is the catalyst precursor, CO₂ is a byproduct from the production of carbon nanotubes from CO. To remove CO₂, the reactor effluent can be passed through a bed of sodium hydroxide pellets. The sodium hydroxide reacts with CO₂ producing sodium carbonate (Na₂CO₃) and water (H₂O). The water is reabsorbed by the sodium hydroxide and sodium carbonate, and these hydrated products are periodically removed from the gas conditioning vessel.

The cleaned feedstock gas (e.g., CO) leaves the process at lower pressure than it entered the process, and the gas then enters a recirculation means 12, such as a pump, fan, blower, compressor, or other element for increasing the pressure in a gas flow and delivering that gas from a lower pressure to a higher pressure environment. The gas pressure is increased by performing mechanical work on the gas.

In one embodiment, and in particular, in an embodiment in which CO is the carbon-containing feedstock gas and Fe(CO)₅ is the catalyst precursor, a suitable recirculation means is a diaphragm compressor, which is suitable for delivering modest flows at the pressures (typically 3-300 atmospheres) at which the process proceeds efficiently.

In the present invention, the catalyst precursor gas sources (such as 3a, 3b, . . . 3n) need not all be individual and distinct as suggested by FIG. 1, and, as such, one source can alternatively feed several gas conduits (such as 4a, 4b, . . . 4n). Additionally, multiple conduit reactors (such as 2) can share common component resources such as elements 1, 9, 10, 11, and 12 in FIG. 1.

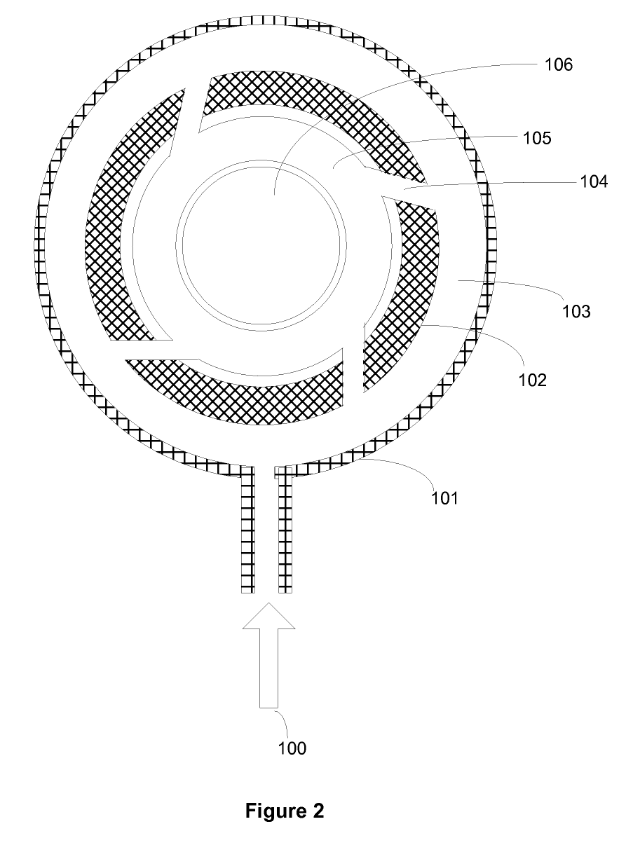

One embodiment of the apparatus, shown schematically in FIG. 1, is a cyclone reactor, shown in cross section in FIG. 2. In one embodiment, the cyclone reactor is a cylindrical reactor. In FIG. 2, a cross-sectional slice of such a reactor, 100 is a port for introducing the catalyst precursor gas stream comprising a catalyst precursor and a diluent gas and/or carbon-containing feedstock gas, such as CO. The catalyst precursor gas stream is usually kept at a temperature below the decomposition temperature of the catalyst precursor. 101 is the reactor wall. 102 is thermal insulation. 103 is the portion of the reactor where the catalyst precursor gas resides before being injected into the hot carbon-containing gas stream through one of multiple catalyst precursor injection conduits 104. The main carbon-containing feedstock flow is flowing circumferentially in section 105 which is a cross section of a cyclone with the catalyst precursor injection conduits 104 arranged around the periphery of this space. In section 105, the catalyst precursor is heated above its decomposition temperature, forms active catalyst clusters and catalyzes the initiation, formation and growth of carbon nanotubes. This cross-sectional slice of the cyclone reactor would be repeated so that there would be multiple points of injection along the length of the reactor which lies perpendicular to the cross section shown in FIG. 2. For example, in this embodiment, there are four catalyst injection conduits 104. If there were ten points of injection along the length of the reactor and four conduits per level, then there would be 40 points of catalyst precursor injection along the reactor's length. With respect to FIG. 2, the reacting flow circulates in a cylindrical flow down (perpendicular to the plane of the figure) the cyclone section 105, reaches the end of that section, and then flows through cylindrical conduit 106, the effluent of which flows to a heat exchanger. This cyclone reactor can be configured as is known to those skilled in the art so that the gas/solids separation is also accomplished in the reactor instead of requiring a separate gas/solid separation means.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method for producing carbon nanotubes comprising the steps of:
(a) providing a carbon-containing feedstock gas stream comprising a carbon-containing feedstock gas in a conduit reactor wherein the temperature of the carbon-containing feedstock gas is in a range between about 500° C. and about 2000° C.; and
(b) injecting more than one catalyst precursor gas stream comprising a transition-metal catalyst precursor at different sequential locations along the longitudinal axis of the conduit reactor, wherein each catalyst precursor mixes with the carbon-containing feedstock gas, and decomposes to form active catalyst clusters in the carbon-containing feedstock gas, and wherein the active catalyst clusters catalyze the formation of carbon nanotubes from the carbon-containing feedstock gas in a carbon feedstock mixed stream.

2. The method of claim 1 wherein the injecting step further comprises controlling temperature, pressure, flow or a combination thereof of the catalyst precursor gas stream to promote the formation of metal catalyst clusters active for carbon nanotube initiation and growth.

3. The method of claim 2 wherein the temperature of the catalyst precursor gas is controlled.

4. The method of claim 1 wherein the catalyst precursor streams comprise different catalyst precursors.

5. The method of claim 1 wherein heat is transferred to or from the carbon feedstock mixed stream.

6. The method of claim 1 further comprising removing heat from the carbon feedstock mixed stream exiting the reactor and returning the heat to the carbon-containing feedstock gas provided to the conduit reactor.

7. The method of claim 1 further comprising separating the carbon nanotube material from the carbon feedstock mixed stream by a gas/solids separation means.

8. The method of claim 7, wherein the separating comprises passing the carbon feedstock mixed stream through a filter.

9. The method of claim 1 further comprising modifying the composition of the gas stream after separating the carbon nanotube material from the carbon feedstock mixed stream.

10. The method of claim 9 wherein the composition modification comprises removal of gaseous reaction products.

11. The method of claim 1 further comprising recirculating the carbon-containing feedstock gas.

12. The method of claim 11 wherein recirculating is done by mechanical means of gas compression.

13. The method of claim 1, wherein the carbon-containing feedstock gas comprises carbon monoxide.

14. The method of claim 1 where the carbon-containing feedstock gas is at a pressure between about 3 and about 300 atmospheres.

15. The method of claim 14 where the carbon-containing feedstock gas is at a pressure between about 10 and about 100 atmospheres.

16. The method of claim 1, wherein at least one of the catalyst precursor gas streams comprises at least one transition metal selected from the group consisting of Group VIB metals, Group VIIIB metals, and mixtures thereof.

17. The method of claim 1, wherein the transition-metal catalyst precursor comprises a metal-containing compound comprising a metal selected from the group consisting of tungsten, molybdenum, chromium, iron, nickel, cobalt, rhodium, ruthenium, palladium, osmium, iridium, platinum and mixtures thereof.

18. The method of claim 17, wherein the metal-containing compound is a metal carbonyl.

19. The method of claim 18, wherein the metal carbonyl is selected from the group consisting of Fe(CO)₅, Co(CO)₆, and mixtures thereof.

20. The method of claim 17, wherein the metal-containing compound is a metallocene.

21. The method of claim 20, wherein the metallocene is selected from the group consisting of ferrocene, cobaltocene, ruthenocene and mixtures thereof.

22. The method of claim 1, wherein at least one of the catalyst precursor gas streams comprises CO.

23. The method of claim 1, wherein the transition-metal catalyst precursor is added to the carbon-containing feedstock gas steam to result in a catalyst precursor concentration of about 0.01 ppm to about 100 ppm of the carbon containing feedstock.

24. The method of claim 1, wherein the transition-metal catalyst precursor is added to the carbon-containing feedstock gas stream to result in a catalyst precursor concentration of about 0.1 ppm to about 10 ppm of the carbon containing feedstock.

25. The method of claim 1, wherein at least one of the catalyst precursor streams is provided at a temperature in the range of from about 70° C. to about 300° C.

26. The method of claim 1, wherein the carbon-containing feedstock stream is provided at a temperature in the range of from about 900° C. to about 1100° C.

27. The method of claim 1 further wherein the catalyst precursor gas stream, the carbon-containing feedstock stream or both further comprises a catalyst promoter.

28. The method of claim 27, wherein the catalyst promoter is selected from the group consisting of thiophene, H₂S, volatile lead, bismuth compounds and combinations thereof

29. The method of claim 1 wherein the catalyst precursor gas stream further comprises a nucleating agent.

30. The method of claim 29, wherein the nucleating agent is laser light photons.

31. The method of claim 29, wherein the nucleating agent comprises a nucleating metal that is different than the transition metal in the catalyst precursor.

32. The method of claim 31, wherein the nucleating metal comprises a decomposition product of a metal-containing compound selected from the group consisting of Ni(CO)₄, W(CO)₆, Mo(CO)₆, and mixtures thereof.

33. An apparatus for producing carbon nanotubes comprising:
(a) a gas stream conduit reactor which has a longitudinal axis and which is capable of providing a carbon-containing feedstock gas at a temperature between about 500° C. and about 2000° C.;
(b) more than one gaseous catalyst precursor conduit connected to the gas stream conduit reactor at sequential different locations along the longitudinal axis of the reactor to provide more than one catalyst precursor gas stream to the gas stream conduit reactor at different sequential locations along the longitudinal axis of the reactor; and
(c) more than one mixing zone along the longitudinal axis of the gas stream conduit reactor wherein each mixing zone is associated with an inlet of one of the gaseous catalyst precursor conduits and in which zone the carbon-containing feedstock gas stream mixes with the catalyst precursor gas streams provided along the longitudinal axis of the reactor, wherein each of more than one mixing zone is maintained under reaction conditions to form carbon nanotubes, and wherein the carbon-containing feedstock gas and carbon nanotubes are contained in a carbon feedstock mixed stream.

34. The apparatus of claim 33 wherein each of the gaseous catalyst precursor conduits is associated with a gaseous catalyst precursor conduit control element to maintain catalyst precursor gas parameters of temperature, pressure, and flow conducive to the initiation of formation of active catalyst for the production of carbon nanotubes.

35. The apparatus of claim 34 wherein the gaseous catalyst precursor conduit control element controls the temperature of the gaseous catalyst precursor.

37. The apparatus of claim 36 further comprising more than one conduit reactor control element associated with the mixing zones along the along the longitudinal axis of the gas stream conduit reactor.

38. The apparatus of claim 37 wherein the more than one conduit reactor control element controls the temperature of the more than one mixing zone.

39. The apparatus of claim 33 further comprising a means for heat recovery from the flow exiting the reactor, wherein the recovered heat is returned to the feedstock flow entering the reactor.

40. The apparatus of claim 33 further comprising a means for gas/solids separation.

41. The apparatus of claim 33 further comprising a means for gas composition modification subsequent to nanotube formation.

42. The apparatus of claim 41 wherein the means for gas composition modification removes gaseous reaction byproducts.

43. The apparatus of claim 33 comprising a means for gas recirculation.

44. The apparatus of claim 43 wherein the means for gas recirculation operates mechanically by gas compression.
